(19) United States
(12) Patent Application Publication
(10) Pub. No.: US 2026/0154790 A1
(43) Pub. Date: Jun. 4, 2026

(54) LEARNING AND RECONSTRUCTION METHOD FOR REDUCING NOISE IN IMAGE BY USING NEURAL NETWORK, AND COMPUTING DEVICE FOR PERFORMING SAME

(71) Applicant: Ewha University - Industry Collaboration Foundation, Seoul (KR)

(72) Inventors: Jang-Hwan CHOI, Seoul (KR); Wonjin KIM, Seoul (KR); Sunyoung JUN, Seoul (KR)

(73) Assignee: Ewha University - Industry Collaboration Foundation, Seoul (KR)

(21) Appl. No.: 18/721,226

(22) PCT Filed: Dec. 20, 2022
(86) PCT No.: PCT/KR2022/020799

§ 371 Date: Jun. 18, 2024

(30) Foreign Application Priority Data
Dec. 22, 2021 (KR) 10-2021-0185329

(51) Int. Cl. G06T 5/70; G06T 5/60

(52) U.S. Cl. CPC G06T 5/70; G06T 5/60; G06T 2207/20081; G06T 2207/20084

(57) ABSTRACT

Disclosed are a learning and reconstruction method for reducing noise in an image by using a neural network, and a computing device for performing same. The learning method comprises the steps of: receiving a training image composed of a plurality of frames; repeatedly training a neural network for predicting a frame of a specific point in time from the remaining frames in the training image other than the frame of the specific point in time; and using the trained neural network to repeatedly train a noise reducer for reducing noise in the frame of the specific point in time.

### TECHNICAL FIELD

The following description relates to a learning and restoration method for effectively removing noise from a low-quality image and restoring the image to a high-quality image using an unsupervised learning-based neural network, and a computing device that performs the same.

### BACKGROUND ART

With the widespread application of X-ray computed tomography (CT) in clinical diagnosis, public concern about excessive radiation doses administered to patients is increasing. However, reducing the radiation dose inevitably generates server noise, affecting the judgment and confidence of a radiologist.

Over the past few decades, various iterative algorithm methods for low-dose computed tomography (LDCT) image reconstruction have been proposed. In general, these algorithms show satisfactory performance in improving image quality by optimizing an objective function, but the practical application of these algorithms is limited due to computational burden and sensitive parameters.

Some image post-processing methods are computationally more efficient and effective than these iterative reconstruction algorithms. Block-matching and three-dimensional filtering (BM3D) is one of excellent methods for image post-processing in the field of CT imaging.

However, these conventional post-processing methods often have edge blurring or characteristic residual defects that occur during image generation, given the uneven distribution of reconstructed noise. Recently, an image quality improvement method applying a machine-learning based approach for noise reduction in LDCT has shown excellent performance improvement.

Basically, the image quality improvement method is applied to improving image quality based on an encoder-decoder structure, which takes an original image as an input to a neural network and outputs an improved image. Among these learning-based noise removal methods, the most common and direct method is to map a low-quality image to a high-quality image through a deep neural network. In other words, the method is a supervised learning method that compares a result extracted from a deep neural network structure having the encoder-decoder structure to a high-quality ground truth image.

The method effectively extracts a meaningful feature from an original image, generates a latent feature, and restores the image through the generated latent feature. This allows restoration of a higher-quality image from a noisy image based on a learned feature and representation. In particular, there is a method to extract patches from an LDCT image and extract corresponding patches from LDCT also. The method has greatly improved the performance of noise removal by better maintaining a detailed feature of an image.

However, the supervised learning-based method requires a ground truth image with improved quality compared to an original image for learning. To obtain a labeled image, images need to be filmed twice in a same environment, and securing large-scale learning data including such ground truth in a real environment is very difficult and takes a lot of time and money.

For example, in an LDCT image, a patient needs to be scanned twice consecutively at normal and low doses to have well-paired clinical scans at different dose levels. In addition, even when the same patient data is obtained at different dose levels, perfectly matching data may be limited due to physical activity and inevitable slight movement of the position of scanning.

Accordingly, network performance may be affected and blurred details or spurious information may occur in a resulting image. In addition, lack of paired data between an LDCT image and a high-resolution CT image is one of the factors limiting widespread application of deep learning in reconstruction of an LDCT image.

### DISCLOSURE OF THE INVENTION

### Technical Goals

The present disclosure provides a method and device for restoring a low-quality original image to a high-quality image by training a neural network based on a difference between a frame of a specific timepoint extracted from a training image and a frame of a specific timepoint predicted by the neural network and repeatedly training a noise reducer based on a difference between a frame of a specific timepoint predicted by the trained neural network and a frame of a specific timepoint in which noise was reduced by the noise reducer.

### Technical Solutions

A training method according to an embodiment may include receiving a training image comprising a plurality of frames, repeatedly training a neural network that predicts a frame of a specific timepoint from frames of remaining timepoints excluding the specific timepoint in the training image, and repeatedly training, using the trained neural network, a noise reducer that reduces noise of the frame of the specific timepoint, wherein the repeated training of the neural network may include repeatedly training the neural network based on a difference between a frame of a specific timepoint extracted from the training image and a frame of a specific timepoint predicted by the neural network, and wherein the repeated training of the noise reducer may include repeatedly training the noise reducer based on a difference between a frame of a specific timepoint predicted by the trained neural network and a frame of a specific timepoint in which noise has been reduced by the noise reducer.

Noise of the frame of the specific timepoint predicted by the neural network may be less than noise of the plurality of frames included in the training image.

Noise of a frame of a specific timepoint that is input to the noise reducer may be greater than noise of a frame of a specific timepoint included in the training image.

The repeated training of the noise reducer may include, when a difference between the frame of the specific timepoint predicted by the trained neural network and a frame of a specific timepoint in which noise has been reduced by a generator (G) of the noise reducer exceeds a preset standard, obtaining noise by inputting a frame adjacent to the frame of the specific timepoint to the generator (G), generating a new noise frame by applying the obtained noise to the frame of the specific timepoint in which the noise has been reduced by the generator (G), and training the generator (G) in a direction that minimizes the difference between the frame of the specific timepoint and the new noise frame.

The neural network may include (i) residual dense networks (RDNs) in which a plurality of residual dense blocks (RDBs) are arranged in a cascade and (ii) non-local (NL) blocks.

A restoration method according to an embodiment may include receiving an original image including a plurality of frames and restoring the received original image into an original image of a higher quality by applying the received original image to a noise reducer, wherein the noise reducer may be repeatedly trained based on a difference between a frame of a specific timepoint, predicted by a trained neural network, of a training image including a plurality of frames and a frame of a specific timepoint in which noise has been reduced by the noise reducer.

The trained neural network may be repeatedly trained based on a difference between a frame of a specific timepoint extracted from the training image and the frame of the specific timepoint predicted by the trained neural network.

Noise of the frame of the specific timepoint predicted by the trained neural network may be less than noise of the plurality of frames included in the training image.

Noise of a frame of a specific timepoint that is input during a process of repeatedly training the noise reducer may be greater than noise of a frame of a specific timepoint included in the training image.

The noise reducer may be configured to, when a difference between the frame of the specific timepoint predicted by the trained neural network and a frame of a specific timepoint in which noise has been reduced by a generator (G) of the noise reducer exceeds a preset standard, obtain noise by inputting a frame adjacent to the frame of the specific timepoint to the generator (G), generate a new noise frame by applying the obtained noise to the frame of the specific timepoint in which the noise has been reduced by the generator (G), train the generator (G) in a direction that minimizes the difference between the frame of the specific timepoint and the new noise frame.

A computing device according to an embodiment may include a processor, wherein the processor may be configured to receive a training image comprising a plurality of frames, repeatedly train a neural network that predicts a frame of a specific timepoint from frames of remaining timepoints excluding the specific timepoint in the training image, and repeatedly train, using the trained neural network, a noise reducer that reduces noise of the frame of the specific timepoint.

The processor may be configured to repeatedly train the neural network based on a difference between a frame of a specific timepoint extracted from the training image and a frame of a specific timepoint predicted by the neural network and to repeatedly train the noise reducer based on a difference between a frame of a specific timepoint predicted by the trained neural network and a frame of a specific timepoint in which noise has been reduced by the noise reducer.

Noise of the frame of the specific timepoint predicted by the neural network may be less than noise of the plurality of frames included in the training image.

Noise of a frame of a specific timepoint that is input to the noise reducer may be greater than noise of a frame of a specific timepoint included in the training image.

The processor may be configured to, when a difference between the frame of the specific timepoint predicted by the trained neural network and a frame of a specific timepoint in which noise has been reduced by a generator (G) of the noise reducer exceeds a preset standard, obtain noise by inputting a frame adjacent to the frame of the specific timepoint to the generator (G), generate a new noise frame by applying the obtained noise to the frame of the specific timepoint in which the noise has been reduced by the generator (G), and train the generator (G) in a direction that minimizes the difference between the frame of the specific timepoint and the new noise frame.

A computing device according to an embodiment may include a processor, wherein the processor may be configured to receive an original image including a plurality of frames and restore the received original image into an original image of a higher quality by applying the received original image to a noise reducer, wherein the noise reducer may be repeatedly trained based on a difference between a frame of a specific timepoint, predicted by a trained neural network, of a training image including a plurality of frames and a frame of a specific timepoint in which noise has been reduced by the noise reducer.

The trained neural network may be repeatedly trained based on a difference between a frame of a specific timepoint extracted from the training image and the frame of the specific timepoint predicted by the trained neural network.

Noise of the frame of the specific timepoint predicted by the trained neural network may be less than noise of the plurality of frames included in the training image.

Noise of a frame of a specific timepoint that is input during a process of repeatedly training the noise reducer may be greater than noise of a frame of a specific timepoint included in the training image.

The noise reducer may be configured to, when a difference between the frame of the specific timepoint predicted by the trained neural network and a frame of a specific timepoint in which noise has been reduced by a generator (G) of the noise reducer exceeds a preset standard, obtain noise by inputting a frame adjacent to the frame of the specific timepoint to the generator (G), generate a new noise frame by applying the obtained noise to the frame of the specific timepoint in which the noise has been reduced by the generator (G), and train the generator (G) in a direction that minimizes the difference between the frame of the specific timepoint and the new noise frame.

### Effects of the Invention

According to an embodiment of the present disclosure, a low-quality image may be restored to a high-quality image by training a neural network based on a difference between a frame of a specific timepoint extracted from a training image and a frame of a specific timepoint predicted by the neural network and repeatedly training a noise reducer based on a difference between a frame of a specific timepoint predicted by the trained neural network and a frame of a specific timepoint in which noise was reduced by the noise reducer.

Through this, the present disclosure may not only provide clinical help by improving a quality of a low-dose computed tomography (LDCT) image, but also protect the health of patients and medical staff by reducing a radiation dose generated in the process of scanning a CT image.

### BRIEF DESCRIPTION OF DRAWINGS

FIG. 1 is a diagram illustrating a structure of a computing device that removes noise using an unsupervised learning-based neural network, according to an embodiment.

FIG. 2 is a diagram illustrating a method of learning a noise removal algorithm performed by a computing device, according to an embodiment.

FIG. 3 is a diagram illustrating a structure of a neural network, according to an embodiment.

FIG. 4 is a diagram specifically illustrating a noise reducer training step, according to an embodiment.

### BEST MODE FOR CARRYING OUT THE INVENTION

Hereinafter, embodiments are described in detail with reference to the accompanying drawings.

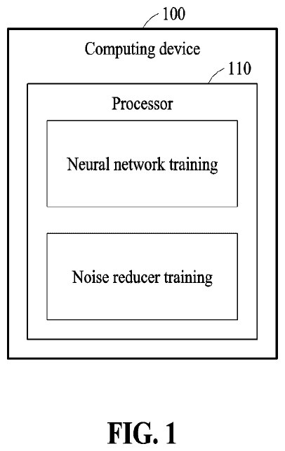

FIG. 1 is a diagram illustrating a structure of a computing device that removes noise using an unsupervised learning-based neural network, according to an embodiment.

Referring to FIG. 1, a computing device 100 of the present disclosure may include a processor 110, and the processor 110 may mainly perform neural network training and noise reducer training. First, the processor 110 may receive a training image including a plurality of temporally consecutive frames and may repeatedly train a neural network that predicts a frame of a specific timepoint from frames of remaining timepoints excluding the specific timepoint in the received training image. For example, in the present disclosure, the training image may be a low-dose computed tomography (LDCT) image, but this is only an example. The training image is not limited thereto and may also be an X-ray fluoroscopy image or a general video image consecutively obtained.

Here, the processor 110 may repeatedly train the neural network based on a difference between a frame of a specific timepoint extracted from a training image and a frame of a specific timepoint predicted by the corresponding neural network.

In addition, the processor 110 may repeatedly train a noise reducer that reduces noise of a frame of a specific point in the received training image. Here, the processor 110 may repeatedly train the corresponding noise reducer based on a difference between a frame of a specific timepoint predicted by the trained neural network and a frame of a specific timepoint in which noise was reduced by the noise reducer.

When a low-quality image is input through the noise reducer trained in this way, the processor 110 of the present disclosure may restore the low-quality image to a high-quality image. For example, when an LDCT image is input to the trained noise reducer, the processor 110 of the present disclosure may restore the LDCT image to a high-dose CT image by reducing noise in the LDCT image.

As described above, the computing device 100 of the present disclosure may train the neural network by using a frame of a specific timepoint among consecutively received frames of a training image as ground truth and train the noise reducer based on a training result of the neural network. Therefore, the computing device 100 of the present disclosure may have an advantage in that, unlike a prior art, the computing device 100 may not require separately constructing high-quality images corresponding to low-quality images to train the noise reducer.

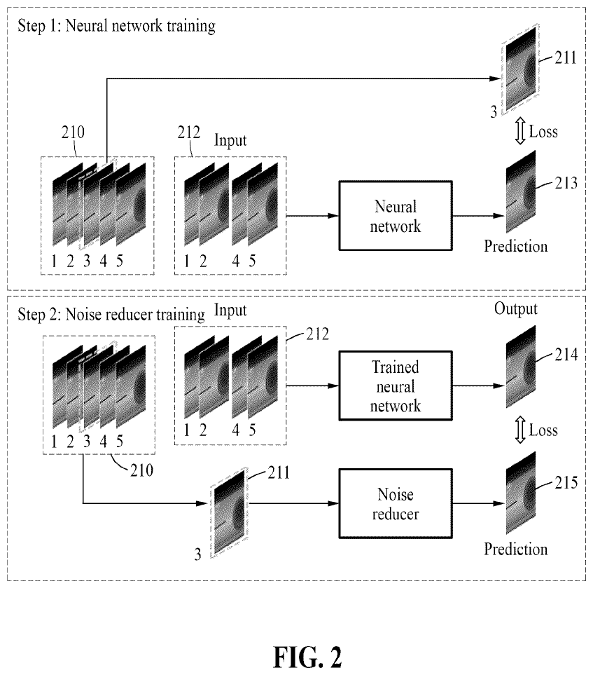

FIG. 2 is a diagram illustrating a method of learning a noise removal algorithm performed by a computing device, according to an embodiment.

Referring to FIG. 2, the noise removal algorithm performed by the computing device 100 may mainly include a neural network training step and a noise reducer training step. First, in the neural network training step, the computing device 100 may train a neural network by using a frame of a specific timepoint in a training image, which includes a plurality of temporally consecutive frames, as ground truth.

More specifically, the computing device 100 may divide the training image into a frame of a specific timepoint and frames of remaining timepoints excluding the frame of the specific timepoint and input the frames of the remaining timepoints to the neural network, and may thus predict the frame of the specific timepoint.

Thereafter, the computing device 100 may repeatedly train the neural network based on a difference between the frame of the specific timepoint extracted from the training image and a frame of a specific timepoint predicted by the corresponding neural network. Here, the computing device 100 may train the neural network in a direction that minimizes the difference between the frame of the specific timepoint extracted from the training image and the frame of the specific timepoint predicted by the neural network.

For example, the neural network training step shown in FIG. 2 illustrates an example of training a neural network by using an intermediate timepoint, that is, frame 3, as ground truth in a training image 210 including temporally consecutive frames 1 to 5. To this end, the computing device 100 may divide the training image 210 into frame 3 211, which is of the intermediate timepoint, and frames (i.e., frames 1, 2, 4, and 5) 212 of remaining timepoints excluding the frame 3 211 of the intermediate timepoint and may input the frames 212 of the remaining timepoints excluding the frame 3 211 of the intermediate timepoint to the neural network. Subsequently, the neural network may output a prediction frame 213 corresponding to the intermediate timepoint from the input frames 212 of the remaining timepoints.

In the above example, using the frame 3 of the intermediate timepoint as the ground truth for training the neural network is only an example. Frames of all timepoints included in the training image 210 may be used as the ground truth for training the neural network.

Thereafter, the computing device 100 may calculate the difference (or a loss) between the frame 3 211 of the intermediate timepoint extracted from the training image 210 and the prediction frame 213 of the intermediate timepoint predicted by the neural network. When the calculated difference is less than or equal to a preset standard, training of the neural network may be terminated.

In addition, noise of the frame of the specific timepoint predicted by the trained neural network provided by the present disclosure may be less than noise of a plurality of frames included in a training image. That is, the computing device 100 of the present disclosure may predict a frame of a specific timepoint at which an objective quality is secured by reducing noise compared to the plurality of frames included in the training image through the trained neural network. The frame predicted in this way may be used as a reference frame for training a noise reducer in the subsequent noise reducer training step.

Subsequently, in the noise reducer training step, the computing device 100 may train a noise reducer that reduces noise of a frame of a specific point in the training image including the plurality of temporally consecutive frames. More specifically, the computing device 100 may divide the training image into the frame of the specific timepoint and the frames of remaining timepoints excluding the frame of the specific timepoint. Then, the computing device 100 may input the frames of the remaining timepoints to the neural network trained in the neural network training step to predict the frame of the specific timepoint, and may input the frame of the specific timepoint to the noise reducer to output a frame of the specific timepoint from which noise has been removed.

Thereafter, the computing device 100 may repeatedly train the noise reducer based on a difference between the frame of the specific timepoint predicted by the trained neural network and the frame of the specific timepoint from which the noise has been reduced by the noise reducer. Here, the computing device 100 may train the noise reducer in a direction that minimizes the difference between the frame of the specific timepoint predicted by the trained neural network and the frame of the specific timepoint from which the noise has been reduced by the noise reducer.

For example, the noise reducer training step shown in FIG. 2 illustrates an example of training a noise reducer that reduces noise of an intermediate timepoint, that is, frame 3, in the training image 210 including the temporally consecutive frames 1 to 5. To this end, the computing device 100 may divide the training image 210 into the frame 3 211, which is of the intermediate timepoint, and the frames (i.e., the frames 1, 2, 4, and 5) 212 of the remaining timepoints excluding the frame 3 211 of the intermediate timepoint.

Subsequently, the computing device 100 may input the frames 212 of the remaining timepoints excluding the frame 3 211 of the intermediate timepoint to the trained neural network to output a prediction frame 214 corresponding to the intermediate timepoint, and may input the frame 3 211 of the intermediate timepoint to the noise reducer to output a frame 3 215 of the intermediate timepoint from which the noise has been reduced.

Finally, the computing device 100 may calculate a distance between the prediction frame 214 of the intermediate timepoint predicted by the trained neural network and the frame 3 215 of the intermediate timepoint from which the noise has been reduced by the noise reducer. When the calculated difference is less than or equal to a preset standard, the computing device 100 may terminate training of the noise reducer.

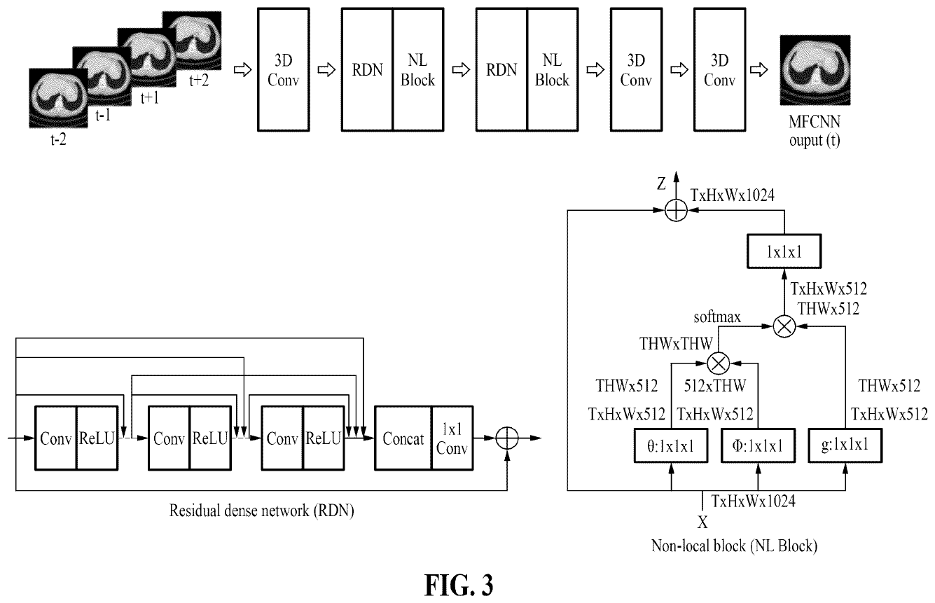

FIG. 3 is a diagram illustrating a structure of a neural network, according to an embodiment.

For example, the neural network provided by the present disclosure may be a multi-frame convolution neural network (MFCNN) and may be configured through a residual dense network (RDN) and a non-local block (NL Block) as shown in FIG. 3. First, the RDN that constitutes the neural network may arrange a plurality of residual dense blocks (RDBs) in a cascade to maximize the hierarchical characteristic, so that high noise reduction performance may be obtained for the intermediate frame predicted by the corresponding neural network.

Subsequently, the NL Block may determine a pixel of a current frame, which is a subject of image quality improvement, having a high correlation with pixels of a previous frame and may utilize the pixel relatively more to improve a pixel quality of the current frame.

In the way described above, the computing device 100 of the present disclosure may obtain, through the neural network including the RDN and the NL block, a frame of a specific timepoint having an objective quality with an improved peak signal-to-noise ratio (PSNR) or an improved structural similarity index (SSIM).

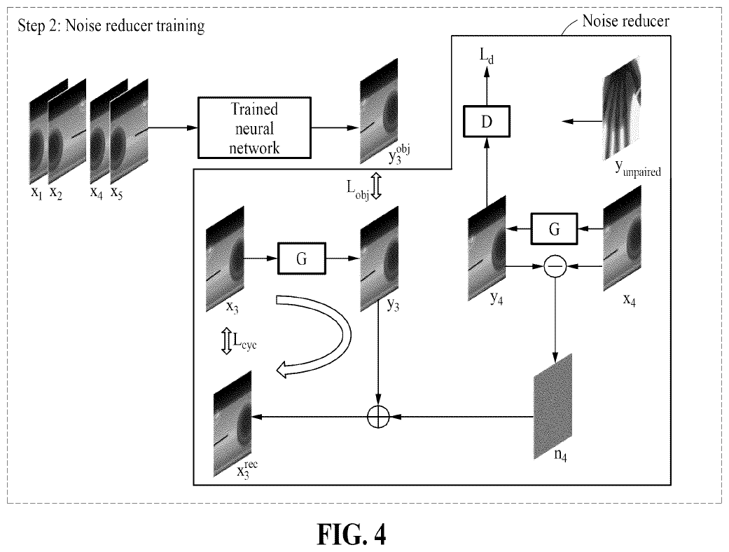

FIG. 4 is a diagram specifically illustrating a noise reducer training step, according to an embodiment.

The noise reducer training step shown in FIG. 4 illustrates a process of training a noise reducer using a frame of an intermediate timepoint in a training image including a plurality of temporally consecutive frames. Here, using the frame of the intermediate timepoint for training the noise reducer is only an example, and embodiments are not limited thereto. Frames of all timepoints included in the training image may be used to train the noise reducer.

More specifically, the computing device 100 of the present disclosure may divide the training image including the plurality of temporally consecutive frames x₁ to x₅ into the frame of the intermediate timepoint x₃ and remaining frames x₁, x₂, x₄, and x₅ excluding the frame of the intermediate timepoint x₃.

Thereafter, the computing device 100 may input the remaining frames x₁, x₂, x₄, and x₅ excluding the frame x₃ of the intermediate timepoint, divided in the training image, to the trained neural network, and the trained neural network may predict a frame

$${y}_{3}^{obj}$$

of the intermediate timepoint from the remaining frames x₁, x₂, x₄, and x₅ excluding the frame x₃ of the intermediate timepoint. Here, the frame

$${y}_{3}^{obj}$$

of the intermediate timepoint predicted by the trained neural network may be used as a reference frame for training the noise reducer because the noise may have been reduced and accordingly the objective quality may have been secured.

In addition, the computing device 100 may input the frame x₃ of the intermediate timepoint, divided in the training image, to the noise reducer, and the noise reducer may input the input frame x₃ of the intermediate timepoint to a generator G to output a frame y₃ of the intermediate timepoint from which the noise has been reduced.

Here, when the difference L_{obj} between the frame

$${y}_{3}^{obj}$$

of the intermediate timepoint predicted by the trained neural network and the frame y₃ of the intermediate timepoint output by the noise reducer exceeds a preset standard, the computing device 100 may repeat training the corresponding noise reducer.

To this end, the noise reducer may apply noise n₂ or n₄, which is obtained by inputting the frame x₂ or x₄ adjacent to the frame x₃ of the intermediate timepoint to the generator G, to the frame y₃ of the intermediate timepoint to generate a new noise frame

$${x}_{3}^{rec} .$$

Subsequently, the noise reducer may improve a noise reduction ability by training the generator G in a direction that minimizes a difference L_{cyc} between the generated new noise frame

$${x}_{3}^{rec}$$

and the frame x₃ intermediate timepoint.

Thereafter, when the difference between the frame

$${y}_{3}^{obj}$$

of the intermediate timepoint predicted by the trained neural network and the frame

$${y}_{3}^{rec}$$

of the intermediate timepoint output by the noise reducer is less than or equal to the preset standard, the computing device 100 may terminate the training of the corresponding noise reducer. When the difference is greater than the preset standard, the computing device 100 may repeat the training of the corresponding noise reducer in the manner described above.

In addition, in order to train a data distribution characteristic of a high-definition frame, the computing device 100 may distinguish, using a discriminator D, a frame that has not been used as an input to the neural network and the noise reducer from a frame, in which noise has been reduced by a trained noise reducer, output by the trained noise reducer. Here, when the frame output by the noise reducer is determined to be a high-definition frame, the discriminator D may output “1” as an L_{d} value, and when the frame output by the noise reducer is determined to be a low-quality frame, the discriminator D may output “0.”

In other words, the computing device 100 of the present disclosure may improve performance of a noise removal algorithm by competitively training the discriminator D, which may accurately determine whether the frame, in which the noise has been reduced by the generator G, output by the generator G is a high-definition frame or a low-quality frame, and the generator G, which may improve noise reduction performance to lower discrimination performance of the discriminator D.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine-readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special-purpose microprocessors, and any one or more processors of any type of digital computer. Generally, a processor will receive instructions and data from read-only memory (ROM) or random-access memory (RAM), or both. Elements of a computer may include at least one processor for executing instructions and one or more memory devices for storing instructions and data. Generally, a computer may also include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, for example, magnetic media such as hard disks, floppy disks, and magnetic tape, optical media such as compact disc ROM (CD-ROM) or a digital versatile disc (DVD), magneto-optical media such as floptical disks, ROM, RAM, flash memory, erasable programmable ROM (EPROM), or electrically erasable programmable ROM (EEPROM). The processor and the memory may be supplemented by, or incorporated in, special-purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multi-tasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of ordinary skill in the art that, in addition to the disclosed embodiments, various other examples modified based on the technical spirit of the present disclosure may be implemented.

1. A training method comprising:
receiving a training image comprising a plurality of frames;
repeatedly training a neural network that predicts a frame of a specific timepoint from frames of remaining timepoints excluding the specific timepoint in the training image; and
repeatedly training, using the trained neural network, a noise reducer that reduces noise of the frame of the specific timepoint,
wherein the repeated training of the neural network comprises:
repeatedly training the neural network based on a difference between a frame of a specific timepoint extracted from the training image and a frame of a specific timepoint predicted by the neural network, and
wherein the repeated training of the noise reducer comprises:
repeatedly training the noise reducer based on a difference between the frame of the specific timepoint predicted by the trained neural network and a frame of a specific timepoint in which noise has been reduced by the noise reducer.

2. The training method of claim 1, wherein noise of the frame of the specific timepoint predicted by the neural network is less than noise of the plurality of frames included in the training image.

3. The training method of claim 1, wherein noise of a frame of a specific timepoint that is input to the noise reducer is greater than noise of a frame of a specific timepoint included in the training image.

4. The training method of claim 3, wherein the repeated training of the noise reducer comprises:
when a difference between the frame of the specific timepoint predicted by the trained neural network and a frame of a specific timepoint in which noise has been reduced by a generator (G) of the noise reducer exceeds a preset standard, obtaining noise by inputting a frame adjacent to the frame of the specific timepoint to the generator (G);
generating a new noise frame by applying the obtained noise to the frame of the specific timepoint in which the noise has been reduced by the generator (G); and
training the generator (G) in a direction that minimizes the difference between the frame of the specific timepoint and the new noise frame.

5. The training method of claim 1, wherein the neural network comprises:
(i) residual dense networks (RDNs) in which a plurality of residual dense blocks (RDBs) are arranged in a cascade; and
(ii) non-local (NL) blocks.

6. A restoration method comprising:
receiving an original image including a plurality of frames:
restoring the received original image into an original image of a higher quality by applying the received original image to a noise reducer,
wherein the noise reducer is repeatedly trained based on a difference between a frame of a specific timepoint, predicted by a trained neural network, of a training image including a plurality of frames and a frame of a specific timepoint in which noise has been reduced by the noise reducer.

7. The restoration method of claim 6, wherein the trained neural network is repeatedly trained based on a difference between a frame of a specific timepoint extracted from the training image and the frame of the specific timepoint predicted by the trained neural network.

8. The restoration method of claim 6, wherein noise of the frame of the specific timepoint predicted by the trained neural network is less than noise of the plurality of frames included in the training image.

9. The restoration method of claim 6, wherein noise of a frame of a specific timepoint that is input during a process of repeatedly training the noise reducer is greater than noise of a frame of a specific timepoint included in the training image.

10. The restoration method of claim 9, wherein the noise reducer is configured to:
when a difference between the frame of the specific timepoint predicted by the trained neural network and a frame of a specific timepoint in which noise has been reduced by a generator (G) of the noise reducer exceeds a preset standard, obtain noise by inputting a frame adjacent to the frame of the specific timepoint to the generator (G):
generate a new noise frame by applying the obtained noise to the frame of the specific timepoint in which the noise has been reduced by the generator (G); and
train the generator (G) in a direction that minimizes the difference between the frame of the specific timepoint and the new noise frame.

11. A computing device comprising a processor, wherein the processor is configured to:
receive a training image comprising a plurality of frames:
repeatedly train a neural network that predicts a frame of a specific timepoint from frames of remaining timepoints excluding the specific timepoint in the training image; and
repeatedly train, using the trained neural network, a noise reducer that reduces noise of the frame of the specific timepoint.

12. The computing device of claim 11, wherein the processor is configured to:
repeatedly train the neural network based on a difference between a frame of a specific timepoint extracted from the training image and a frame of a specific timepoint predicted by the neural network; and
repeatedly train the noise reducer based on a difference between a frame of a specific timepoint predicted by the trained neural network and a frame of a specific timepoint in which noise has been reduced by the noise reducer.

13. The computing device of claim 11, wherein noise of the frame of the specific timepoint predicted by the neural network is less than noise of the plurality of frames included in the training image.

14. The computing device of claim 11, wherein noise of a frame of a specific timepoint that is input to the noise reducer is greater than noise of a frame of a specific timepoint included in the training image.

15. The computing device of claim 14, wherein the processor is configured to:
when a difference between the frame of the specific timepoint predicted by the trained neural network and a frame of a specific timepoint in which noise has been reduced by a generator (G) of the noise reducer exceeds a preset standard, obtain noise by inputting a frame adjacent to the frame of the specific timepoint to the generator (G);
generate a new noise frame by applying the obtained noise to the frame of the specific timepoint in which the noise has been reduced by the generator (G); and
train the generator (G) in a direction that minimizes the difference between the frame of the specific timepoint and the new noise frame.

16. A computing device comprising a processor, wherein the processor is configured to:
receive an original image including a plurality of frames; and
restore the received original image into an original image of a higher quality by applying the received original image to a noise reducer,
wherein the noise reducer is repeatedly trained based on a difference between a frame of a specific timepoint, predicted by a trained neural network, of a training image including a plurality of frames and a frame of a specific timepoint in which noise has been reduced by the noise reducer.

17. The computing device of claim 16, wherein the trained neural network is repeatedly trained based on a difference between a frame of a specific timepoint extracted from the training image and the frame of the specific timepoint predicted by the trained neural network.

18. The computing device of claim 16, wherein noise of the frame of the specific timepoint predicted by the trained neural network is less than noise of the plurality of frames included in the training image.

19. The computing device of claim 16, wherein noise of a frame of a specific timepoint that is input during a process of repeatedly training the noise reducer is greater than noise of a frame of a specific timepoint included in the training image.

20. The computing device of claim 19, wherein the noise reducer is configured to:
when a difference between the frame of the specific timepoint predicted by the trained neural network and a frame of a specific timepoint in which noise has been reduced by a generator (G) of the noise reducer exceeds a preset standard, obtain noise by inputting a frame adjacent to the frame of the specific timepoint to the generator (G);
generate a new noise frame by applying the obtained noise to the frame of the specific timepoint in which the noise has been reduced by the generator (G); and
train the generator (G) in a direction that minimizes the difference between the frame of the specific timepoint and the new noise frame.
